(19) United States
(12) Patent Application Publication
(10) Pub. No.: US 2003/0050801 A1
(43) Pub. Date: Mar. 13, 2003

(54) System and user interface for planning and monitoring patient related treatment activities

(76) Inventors: Linda K. Ries, West Chester, PA (US); Sandeep Dighe, Pune (IN)

Correspondence Address: Siemens Corporation, Intellectual Property Department, 186 Wood Avenue South, Iselin, NJ, 08830, US

(21) Appl. No.: 10/219,832

(22) Filed: Aug. 15, 2002

Related U.S. Application Data
(60) Provisional application No. 60/313,661, filed on Aug. 20, 2001.

(51) Int. Cl. G06F 17/60

(52) U.S. Cl. 705/2

(57) ABSTRACT

An activity planner for a healthcare information system includes a user interface and a processor. The user interface includes an input device and a display. The input device is adapted to receive input information related to a care plan for a patient, wherein the care plan includes a schedule of activities related to treatment of a problem for the patient. The display is adapted to present, in a single view, the input information, output information related to the care plan, and an activity chart related to the care plan, wherein the activity chart provides a graphical representation of the schedule of activities in the care plan. The processor is adapted to generate the output information responsive to receiving the input information.

### CROSS-REFERENCE TO RELATED APPLICATIONS

The present application is a non-provisional application of provisional application having Ser. No. 60/313,661 filed by Linda Ries on Aug. 20, 2001.

### FIELD OF THE INVENTION

The present invention generally relates to healthcare information systems. More particularly, the present invention relates to an activity planner for a healthcare information system and method therefor.

### BACKGROUND OF THE INVENTION

Modern healthcare requires the concurrent provision of services by many health-care workers to many patients. In order to accomplish this, healthcare delivery has been organized into specialized departments such as, for example, nursing, laboratory, pharmacy and radiology departments. Each department has responsibility for accomplishing its particular, often specialized, subset of tasks. Unfortunately, this has resulted in fragmented~patient care and sub-optimal healthcare operations. A single healthcare process, such as the ordering and administration of a medication, sometimes requires the participation of multiple health-care workers that may be associated with multiple departments resulting in increased opportunities for error and delay.

Clinical and healthcare information systems have been computerized to help health care workers perform individual tasks. However, most systems typically have limited capability to manage a sequence of the individual tasks involved in healthcare processes. This is particularly true when the processes require the involvement of one or more health-care workers associated with one or more departments.

Some computerized systems include workflow management systems that are designed to manage complex processes, called workflows, which include multiple individual work steps, forming a sequence and schedule of tasks, performed by one or more workers associated with one or more departments. These systems permit customized configuration of the workflows, as well as continuous monitoring and management while the workflows are in progress. Preferably, these systems support configuration of the workflows at a local level where the workers implement the workflows.

Some computerized systems also have a user interface permitting workers to input information, such as via a keyboard or a touch screen, and receive output information, such via a display or recorded format on paper or a recording medium, related to the workflows. Workers use the user interface to perform tasks such as, for example, searching and reporting results, ordering goods and services, documenting clinical and nursing care, and capturing financial or operational data.

It would be desirable for a computerized systems to present a patient's activities and orders without the ability to view the actual result or documentation that would be associated with the performance and completion of the task from the same display. The computerized system would allow the entry of the results or outcomes directly from the display of the orders and activities. Users could navigate a single computerized system to view and documents, the results and the outcomes. The computerized system would incorporate the results or outcomes for patient activities and orders in a single display view. The computerized system would permit the ability to document the charting of the results and outcomes in the same display view, and provide for the integration of the charting across the computerized system. The computerized system would provide a consolidated display view of all of the patient activities, orders and corresponding outcomes. The computerized system would also provide the ability to modify and chart performance of activities and orders for the patient from the same display view. Accordingly, there is a need for an improved activity planner and corresponding method that would meet these and other desirable features of a healthcare information system.

### SUMMARY OF THE INVENTION

An activity planner and corresponding a method for a healthcare information system includes a user interface and a processor. The user interface includes an input device and a display. The input device is adapted to receive input information related to a care plan for a patient, wherein the care plan includes a schedule of activities related to treatment of a problem for the patient. The display is adapted to present, in a single view, the input information, output information related to the care plan, and an activity chart related to the care plan, wherein the activity chart provides a graphical representation of the schedule of activities in the care plan. The processor is adapted to generate the output information responsive to receiving the input information.

These and other aspects of the present invention are further described with reference to the following detailed description and the accompanying figures, wherein the same reference numbers are assigned to the same features or elements illustrated in different figures. Note that the figures may not be drawn to scale. Further, there may be other embodiments of the present invention explicitly or implicitly described in the specification that are not specifically illustrated in the figures and visa versa.

### BRIEF DESCRIPTION OF THE DRAWINGS

FIG. 1 illustrates a healthcare information system including an activity planner, in accordance with a preferred embodiment of the present invention.

FIG. 2 illustrates a clinical workflow model associated with the activity planner, as shown in FIG. 1, in accordance with the preferred embodiment of the present invention.

FIG. 3 illustrates a display window of the activity planner, as shown in FIG. 1, showing a patient problems view, in accordance with a preferred embodiment of the present invention.

FIG. 4 illustrates a display window of the activity planner, as shown in FIG. 1, showing a care plan view, scrolled to the left side of the window, in accordance with a preferred embodiment of the present invention.

FIG. 5 illustrates a display window of the activity planner, as shown in FIG. 1, showing a care plan view, scrolled to the right side of the window, in accordance with a preferred embodiment of the present invention.

FIG. 6 illustrates a display window of the activity planner, as shown in FIG. 1, showing a care plan view, scrolled to the left side of the window and showing an activity chart, in accordance with a preferred embodiment of the present invention.

FIG. 7 illustrates a display window of the activity planner, as shown in FIG. 1, showing a day view, scrolled to the left side of the window, in accordance with a preferred embodiment of the present invention.

FIG. 8 illustrates a display window of the activity planner, as shown in FIG. 1, showing a day view, scrolled to the right side of the window, in accordance with a preferred embodiment of the present invention.

FIG. 9 illustrates a display window of the activity planner, as shown in FIG. 1, showing a day view, scrolled to the left side of the window and showing an activity chart, in accordance with a preferred embodiment of the present invention.

FIG. 10 illustrates a display window of the activity planner, as shown in FIG. 1, showing a customized activity chart, in accordance with a preferred embodiment of the present invention.

FIG. 11 illustrates an activity life cycle chart associated with the activity planner, in accordance with a preferred embodiment of the present invention.

FIG. 12 illustrates a display window of the activity planner, as shown in FIG. 1, showing a print activity view, in accordance with a preferred embodiment of the present invention.

### DETAILED DESCRIPTION OF THE PREFERRED EMBODIMENTS

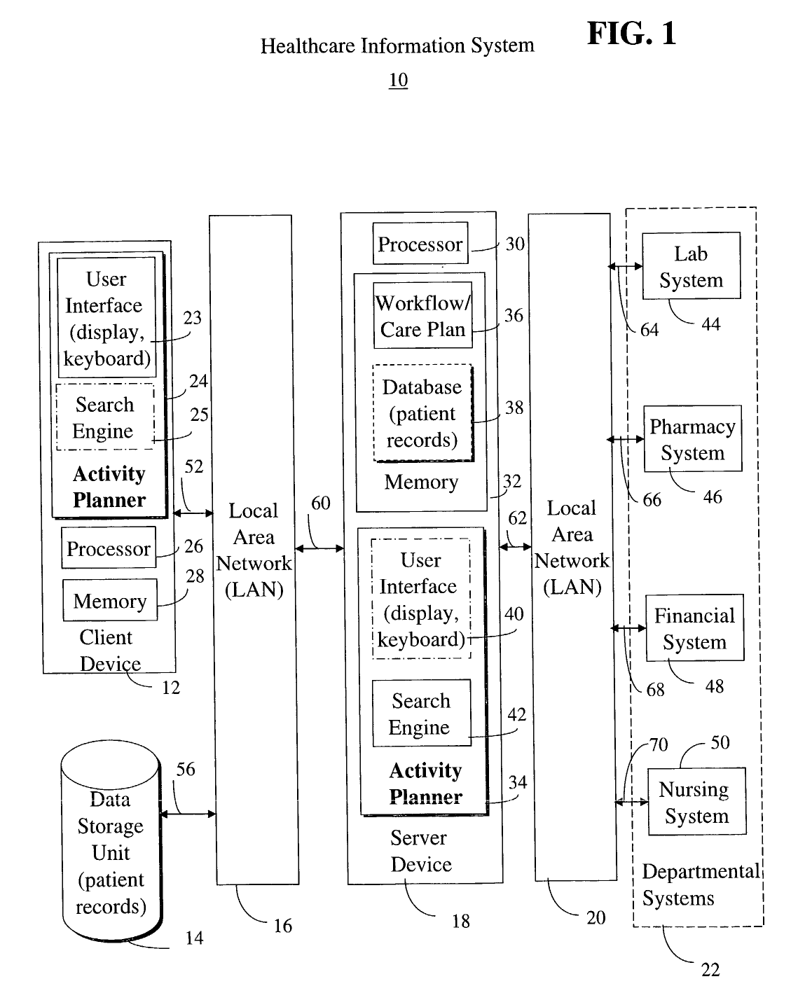

FIG. 1 illustrates a healthcare information system 10 including an activity planner 24 and/or 34, in accordance with a preferred embodiment of the present invention. The healthcare information system 10 generally includes a client device 12, a data storage unit 14, a first local area network (LAN) 16, a server device 18, a second local area network (LAN) 20, and departmental systems 22. The healthcare information system 10 is intended for use by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. In the preferred embodiment of the present invention, the healthcare provider is a hospital. Examples of the people being serviced by the healthcare provider include, without limitation, a patient, a resident, and a client.

The client device 12 generally includes an activity planner 24, a processor 26, and a memory unit 28. The activity planner 24 preferably includes a user interface 23 and a search engine 25, but may also include the processor 26 and the memory unit 28. The client device 12 is preferably implemented as a personal computer. The processor 26 and the memory unit 28 constructed and operate in a manner well known to those skilled in the art of the design of client devices.

The user interface 23 in the client device 12 generally includes an input device that permits a user to input information into the client device 12 and an output device that permits a user to receive information from the client device 12. Preferably, the input device is a keyboard, but also may be a touch screen, a microphone with a voice recognition program, for example. Preferably, the output device is a display, but also may be a speaker, for example. The output device provides information to the user responsive to the input device receiving information from the user or responsive to other activity by the client device 12. For example, the display presents information responsive to the user entering information in the client device 12 via the keypad.

The search engine 25 in the client device 12 permits a user to search for specific information among a large amount of information. The search engine 25 is preferably implemented in software, but may also be implemented in hardware. The dashed lines around the search engine 25 represent that the location the search engine 25 in the client device 12 is an alternative location. In the preferred embodiment of the present invention, the search engine 42 is preferably located in the server device 18 to permit multiple users to have access to the same search engine 42 from multiple client devices.

The data storage unit 14 stores patient records, as well as other information for the hospital information system 10. Preferably, the data storage unit 14 is separate from the client device 12 to permit multiple users to have access to the patient records in the data storage unit 14 from multiple client devices. Preferably, the data storage unit 14 is separate from the server device 18 because of the physical size of the memory required to store all of the desired information. The data storage unit 14 may be implemented as read only memory (ROM), such as on a compact disk (CD) or on a hard drive, or a random access memory (RAM), and the like, as is well know to those skilled in the art of data storage units. Alternatively, the patient records may be stored in the database 38 in the memory unit 32 in the server device 18, as shown in dashed lines, in the memory unit 28 in the client device 12, or in memory units in the departmental systems 22, as the memory size becomes physically smaller, has increased capacity and becomes less expensive. An additional consideration would be the advantages and disadvantages of having the patient records stored in a single centralized memory unit or stored in several decentralized memory units among the data storage unit 14, the client device 12, the server device 18, and the departmental systems 22.

Patient records in the data storage unit 14 generally include any information related to a patient including, without limitation, biographical, financial, clinical, workflow, and care plan information. The patient records may be represented in a variety of file formats including, without limitation, text files such as documents, graphic files such as a graphical trace including, for example, an electrocardiogram (EKG) trace, an electrocardiogram (ECG) trace, and an electroecephologram (EEG) trace, video files such as a still video image or a video image sequence, an audio file such as an audio sound or an audio segment, and visual files, such as a diagnostic image including, for example, a magnetic resonance image (MRI), an x-ray, a positron emission tomagraphy (PET) scan, or a sonogram. The patient record is an organized collection of clinical information concerning one patient's relationship to a healthcare enterprise (e.g. region, hospital, clinic, or department). The patient record can narrowly be considered as a file cabinet or repository with divisions and indexing mechanisms. These divisions resemble a hierarchy with folders, documents and document components, or other objects representing collections of clinical elementary information. Such folder divisions include traditional classifications such as summaries, notes, investigations, orders, medications, correspondence, results, etc. Each individual information element and object resides in a home location in this structure. Revision history can be captured from within this home location.

The first local area network (LAN) 16 provides a communication network among the client device 12, the data storage unit 14 and the server device 18. The second local area network (LAN) 20 provides a communication network between the server device 18 and the departmental systems 22. The first LAN 16 and the second LAN 20 may be the same or different LANs, depending on the particular network configuration and the particular communication protocols implemented. Alternatively, one or both of the first LAN 16 and the second LAN 20 may be implemented as a wide area network (WAN).

The communication paths 52, 56, 60, 62, 64, 66, 68 and 70 permit the various elements, shown in FIG. 1. to communicate with the first LAN 16 or the second LAN 20. Each of the communication paths 52, 56, 60, 62, 64, 66, 68 and 70 are preferably adapted to use one or more data formats, otherwise called protocols, depending on the type and/or configuration of the various elements in the healthcare information systems 10. Examples of the information system data formats include, without limitation, an RS232 protocol, an Ethernet protocol, a Medical Interface Bus (MIB) compatible protocol, an Internet Protocol (I.P.) data format, a local area network (LAN) protocol, a wide area network (WAN) protocol, an IEEE bus compatible protocol, and a Health Level Seven (HL7) protocol.

The I.P. data format, otherwise called an I.P. protocol, uses IP addresses. Examples of the I.P. addresses include, without limitation, Transmission Control Protocol Internet Protocol (TCPIP) address, an I.P. address, a Universal Resource Locator (URL), and an electronic mail (Email) address. The communication paths 52, 56, 60, 62, 64, 66, 68 and 70 each may be formed as a wired or wireless (W/WL) connection. Preferably, the communication paths 52, 56, 60, 62, 64, 66, 68 and 70 are formed as a wired connection. In the case of a wired connection, the I.P. address is preferably assigned to a physical location of the termination point of the wire, otherwise called a jack. The jack is mounted in a fixed location near the location of the various elements. In the case of a wireless connection, I.P. addresses are preferably assigned to the various elements, since the various elements would be mobile. The wireless connection permits the person using the healthcare information system 10 to be mobile beyond the distance permitted with the wired connection.

The server device 18 generally includes a processor 30, a memory unit 32, and an activity planner 34. The memory unit 32 includes a workflow and/or care plan 36 and a database 38 containing patient records. The activity planner 34 preferably includes a user interface 40 and a search engine 42, but may also include the processor 30 and the memory unit 32. The server device 18 is preferably implemented as a personal computer or a workstation. As mentioned above, the database 38 provides an alternate location for storing the patient records, and the user interface 40 is an alternate interface for the user. Therefore, in the preferred embodiment of the present invention, the activity planner includes the user interface 23 in the client device 12 and the search engine 42 in the server device 18. Alternatively, the activity planner includes both the user interface 23 and the search engine 25 in the client device 12. Still alternatively, the activity planner includes both the user interface 40 and the search engine 42 in the server device 18. Still alternatively, the activity planner includes the user interface 40 in the server device 18 and the search engine 25 in the client device.

The activity planner 24 and/or 34 is a program that is used by users in a healthcare information system to initiate, maintain and view current and past treatment care plans for the patients they serve. Orders placed for the patient, regardless of where the user enters them in the healthcare information system, are incorporated into the patient's overall treatment care plan and are accessible via the activity planner. More than a structured view of the treatment care plan; the activity planner is a dynamic user interface that permits users to input the patient's progress by entering performance and outcome information, and outputs results and other outcomes associated with the planned activities and/or orders via a display. The activity planner includes an activity chart, preferably a Gantt chart, which is displayed in the same display window as the care plan. The user is permitted to update and modify the treatment care plan in the activity planner. Hence, the activity planner provides a single user interface that integrates patient's record, the patient's treatment care plan, and the activity chart.

The departmental systems 22 are systems that need access to information or provide information related to the health and/or welfare of people in the care of the healthcare provider. Examples of the departmental systems 22 include, without limitation, a lab system 44, a pharmacy system 46, a financial system 48 and a nursing system 50, as shown in FIG. 1, but may also include a records system, a radiology system, an accounting system, a billing system, and any other system required or desired in a healthcare information system.

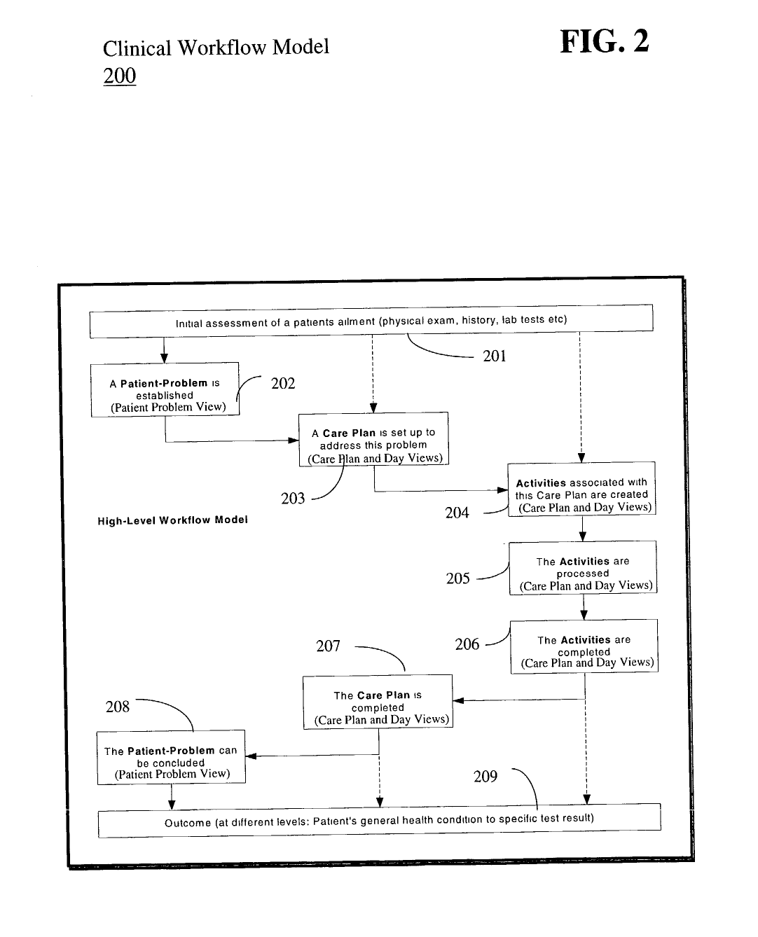

FIG. 2 illustrates a clinical workflow model 200 associated with the activity planner 24 and/or 34, as shown in FIG. 1, in accordance with the preferred embodiment of the present invention.

At step 201, an initial assessment of a patient's ailment is made, such as by performing a physical exam, assessing the patent's medical history, performing lab tests, and the like. From step 201, the workflow model preferably continues to step 202, and alternatively continues to step 203 or step 204.

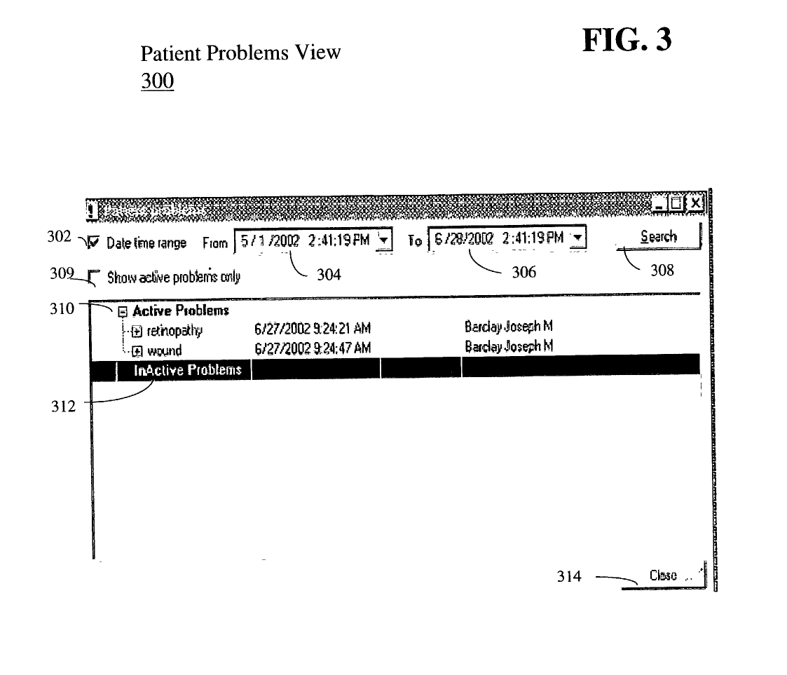

At step 202, a patient problem is established, such as in a patient problem view of the user interface, as shown in FIG. 3. From step 202, the workflow model continues to step 203.

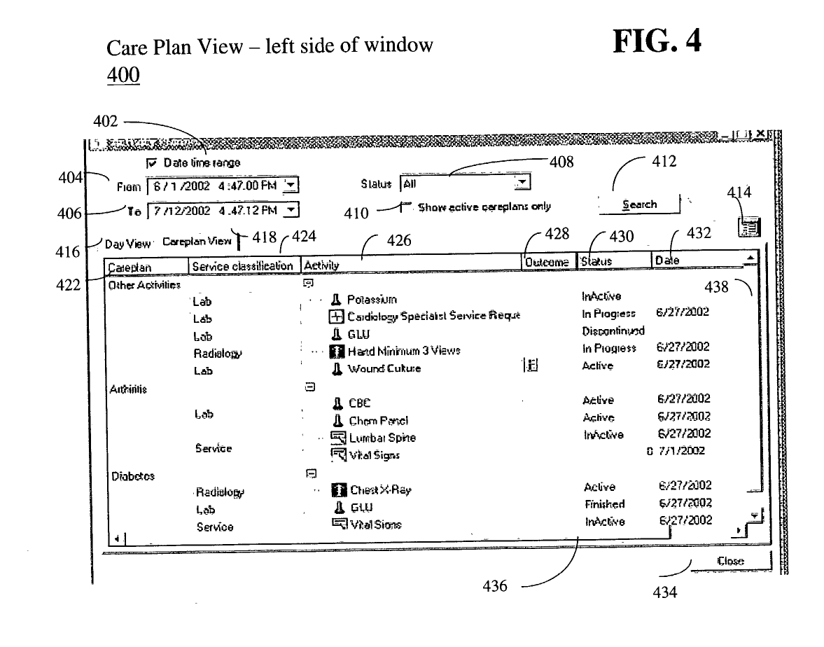

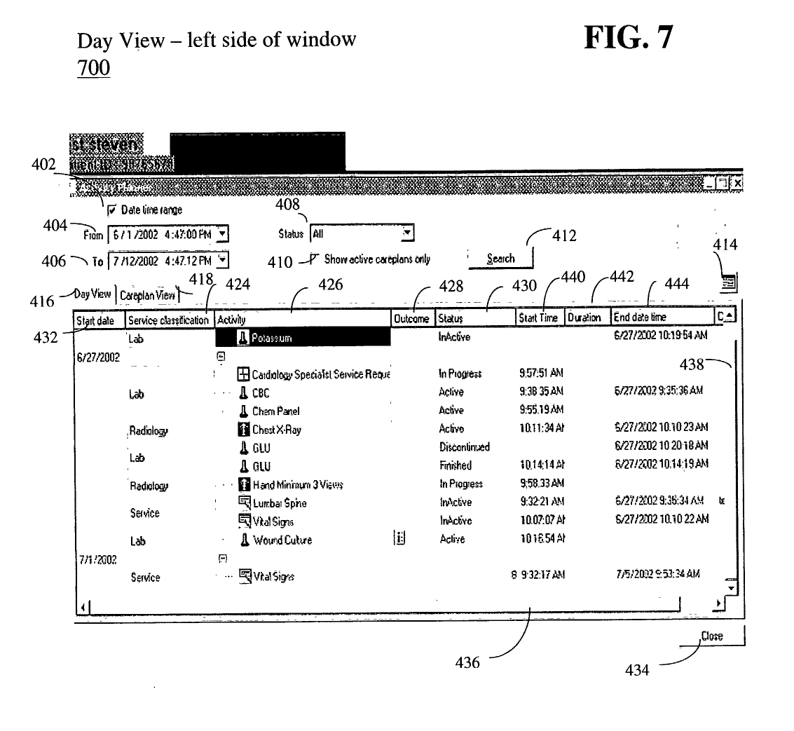

At step 203, a care plan is set up to address the patient's problem. From step 203, the workflow model continues to step 204. In FIG. 2, steps 203 through 207 are viewed and charted in the care plan views, as shown in FIGS. 4, 5 and 6, and in the day views, as shown in FIGS. 7, 8 and 9.

At step 204, the activities associated with the care plan are created. From step 204, the workflow model continues to step 205.

At step 205, the activities are processed. From step 205, the workflow model continues to step 206.

At step 206, the activities are completed. From step 206, the workflow model preferably continues to step 207, and alternatively continues to step 209.

At step 207, the care plan is completed. From step 207, the workflow model preferably continues to step 208, and alternatively continues to step 209.

At step 208, the patient problem is concluded, such as in a patient problem view of the user interface, as shown in FIG. 3. From step 208, the workflow model continues to step 209.

At step 209. the outcome of the care plan is assessed at different levels of health, such as from the patient's general health to a specific test result. If the outcome is favorable, then the patient is discharged from the healthcare enterprise. However, if the outcome is unfavorable, then the workflow model may return to step 201 or other alternatives may be considered outside of the workflow model.

FIG. 3 illustrates a display window of the activity planner, as shown in FIG. 1, showing a patient problems view 300, in accordance with a preferred embodiment of the present invention. The patient problems view 300 includes a date range selection box 302, a start date field 304, an end date field 306, a search button 308, a search active problems only box 309, an active problems display area 310, an inactive problems display area 312, and a close button 314. When the date range selection box 302 is checked, the user is permitted to enter or select a start date in the start date field 304, and to enter or select an end date in the end date field 306. When a user clicks on the search button 308, the activity planner initiates a search of a patient's problems. Responsive to the search, the active problems are displayed in the active problems display area 310, and the inactive problems are displayed in the inactive problems display area 312. When the search active problems only box 309 is selected, only the active problems are displayed in the active problems display area 310. When a user clicks on the close button 314, the activity planner closes the patient problems view 300.

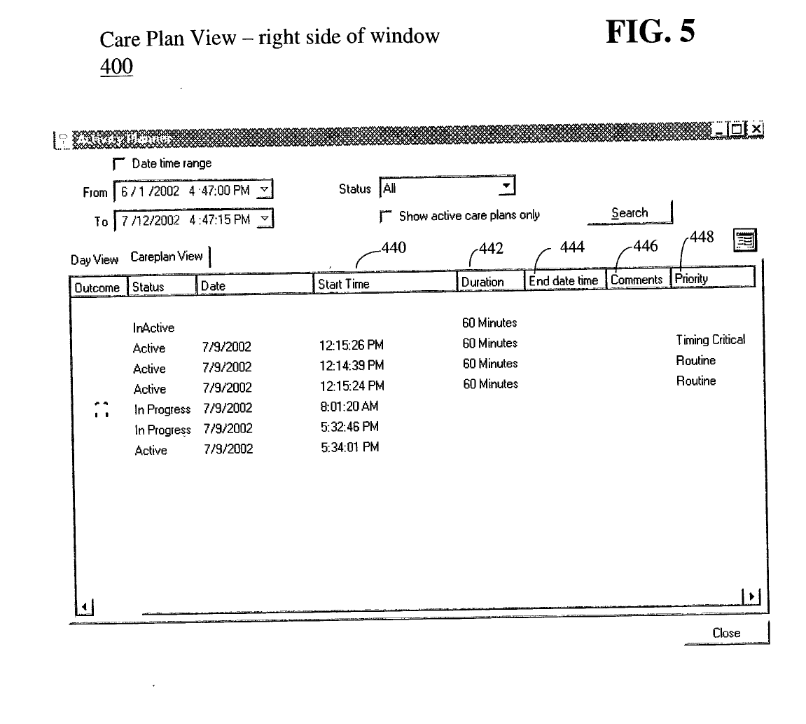

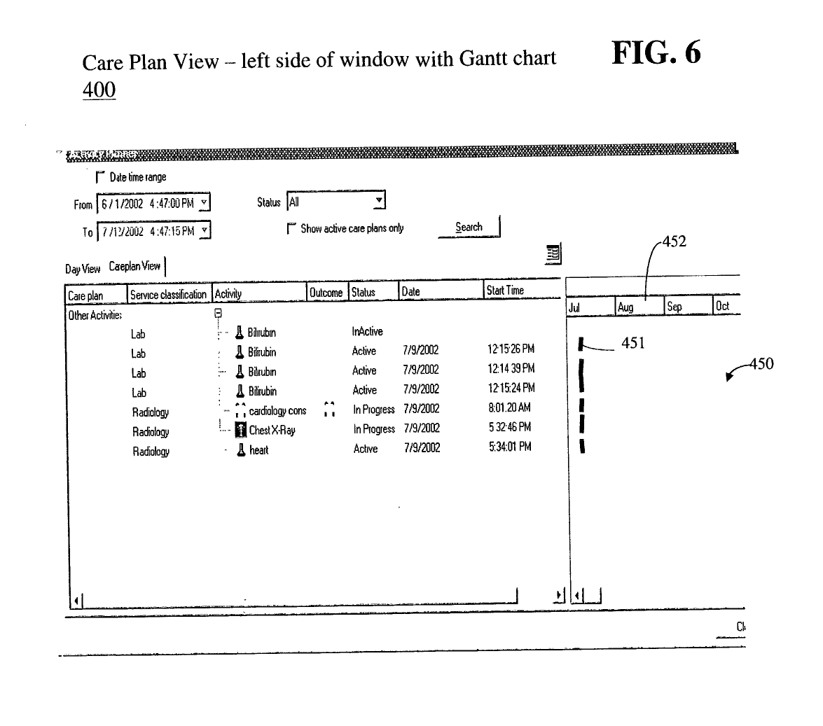

FIGS. 4, 5 and 6 each illustrate a display window of the activity planner, as shown in FIG. 1, showing a care plan view 400, in accordance with a preferred embodiment of the present invention. In particular, FIG. 4 illustrates a display window of the activity planner, as shown in FIG. 1, showing a care plan view 400, scrolled to the left side of the window, in accordance with a preferred embodiment of the present invention. FIG. 5 illustrates a display window of the activity planner, as shown in FIG. 1, showing a care plan view 400, scrolled to the right side of the window, in accordance with a preferred embodiment of the present invention. FIG. 6 illustrates a display window of the activity planner, as shown in FIG. 1, showing a care plan view 400, scrolled to the left side of the window and showing an activity chart 450, in accordance with a preferred embodiment of the present invention.

FIGS. 4, 5 and 6 generally include a date/time range selection box 402, a start date/time field 404, an end date/time field 406, a status field 408, a show active care plans only box 410, a search box 412, an activity chart icon 414, a day view tab 416, a care plan view tab 418, a care plan label 422, a service classification label 424, an activity label 426, an outcome label 428, a status label 430, a start date label 432, a close box 434, a horizontal scroll bar 436, a vertical scroll bar 438 (each referenced in FIG. 4), a start time label 440, a duration label 442, an end date/time label 444, a comments label 446, a priority label 448 (each referenced in FIG. 5), an activity chart 450, a schedule label 452, and a charted activity 451 (each referenced in FIG. 6). Although some of the same elements are shown in more than one of the FIGS. 4, 5 and 6, they are only referenced once using reference numbers to provide clarity to the figures. Preferably, the user may desire deselect and not display some of the labels in the care plan view, such as the service classification label 424 and the comments label 446.

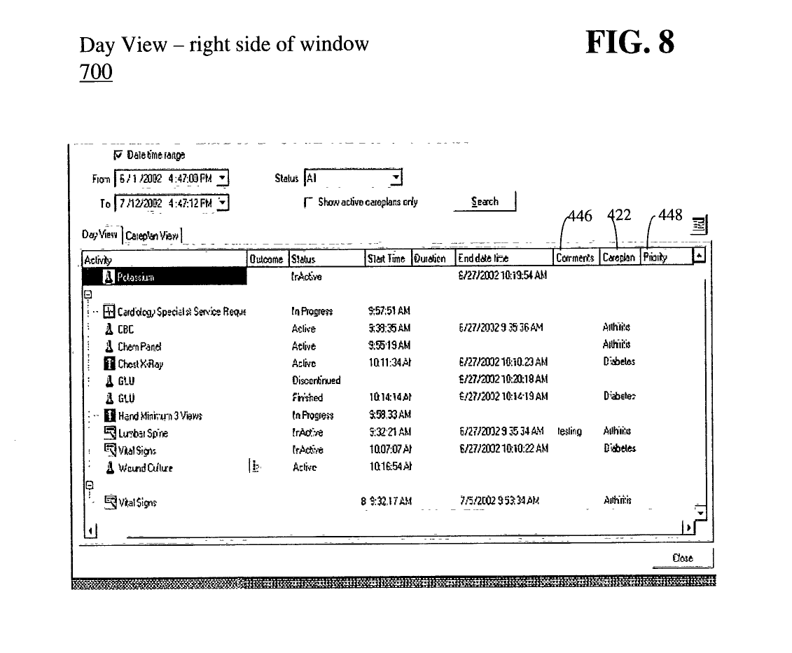

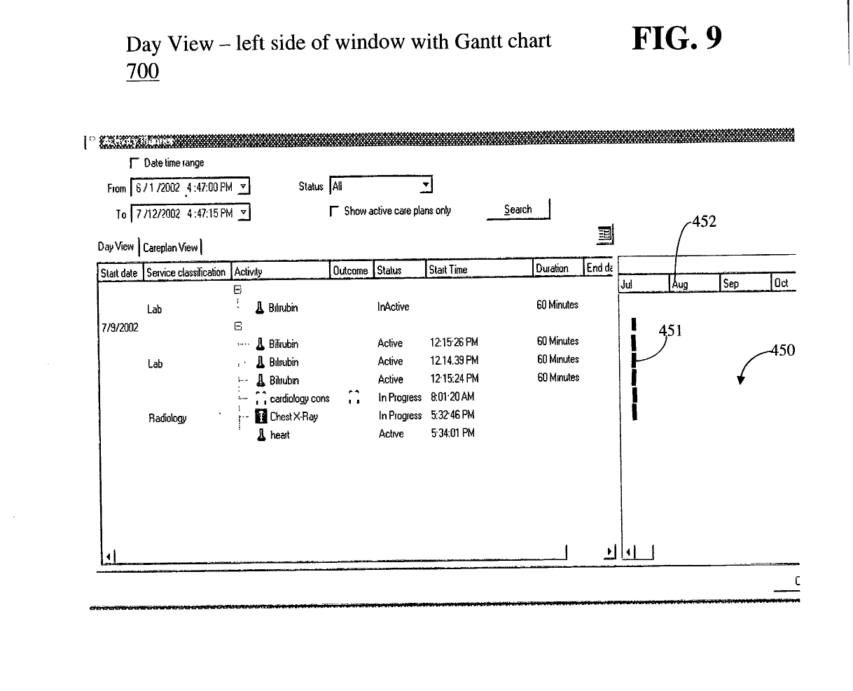

FIGS. 7, 8 and 9 each illustrate a display window of the activity planner, as shown in FIG. 1, showing a day view 700, in accordance with a preferred embodiment of the present invention. In particular, FIG. 7 illustrates a display window of the activity planner, as shown in FIG. 1, showing a day view 700, scrolled to the left side of the window, in accordance with a preferred embodiment of the present invention. FIG. 8 illustrates a display window of the activity planner, as shown in FIG. 1, showing a day view 700, scrolled to the right side of the window, in accordance with a preferred embodiment of the present invention. FIG. 9 illustrates a display window of the activity planner, as shown in FIG. 1, showing a day view 700, scrolled to the left side of the window and showing an activity chart, in accordance with a preferred embodiment of the present invention.

FIGS. 7, 8 and 9 generally include the date/time range selection box 402, the start date/time field 404, the end date/time field 406, the status field 408, the show active care plans only box 410, the search box 412, an activity chart icon 414, the day view tab 416, the care plan view tab 418, the care plan label 422, the service classification label 424, an activity label 426, an outcome label 428, the status label 430, the start date label 432, the close box 434, the horizontal scroll bar 436, the vertical scroll bar 438, the start time label 440, the duration label 442, an end date/time label 444, the comments label 446, the priority label 448, an activity chart 450, the schedule label 452, and the charted activity 451. Preferably, the user may desire deselect and not display some of the labels in the day view, such as the care plan label 422, the start date label 432, and the comments label 446. Although some of the same elements are shown in more than one of the FIGS. 7, 8 and 9, they are only referenced once using reference numbers to provide clarity to the figures. Therefore, FIGS. 7, 8 and 9 include all of the same features of FIGS. 4, 5 and 6, and consequently provide a common user interface for inputting or outputting all of the same information. The difference between the two groups of figures is that FIGS. 4, 5 and 6 illustrate one or more care plans created for the patient to give the user a general view of the patient's care plan. Whereas, FIGS. 7, 8 and 9 illustrate a daily schedule of activities among the one or more care plans for the patient to give the user a more detailed view of the patients care plan. Hence, both the care plan view and the day view present the same information from two different perspectives depending on the user's preference.

Accessing The Activity Planner

The activity planner is a software tool that preferably is related to a single patient record. Hence, the activity planner is preferably accessible when a patient record already has been selected. The purpose of the activity planner is to present the user with a comprehensive view of the care plans for a patient and to provide the user with the ability to perform actions related to the care plan. The activity planner shall open displaying the day view, as shown in FIGS. 7, 8 and 9, by default. The activity planner is available directly as a menu item in a top-level menu of the desktop's menu bar. If no patient is selected, the menu item is grayed out and not available for selection. The activity planner is also available directly as an icon in the desktop's icon-bar. If no patient is selected, the icon is not available for selection. Further, the activity planner is available as a menu-item in a context pop-up menu in a patient browser's patient list window.

General Features Of The Care Plan and Day Views

The activity planner contains many features. To use the activity planner efficiently, the amount of scrolling through a view is minimized. Therefore, the activity planner window is displayed maximized by default. Preferably, the activity planner displays all activities that have any status, other than an invalid status. When the activity planner is opened and no date/time range has been selected, an activities sub-window is scrolled so that the current date is the first to be displayed. If a date/time range filter is active, the activities sub-window displays the first date of that date range on top.

Date/Time Range

The date/time range selection includes the date/time range selection box 402, the start date/time field 404, and end date/time field 406. The date/time range selection box 402 commits a date/time range change to refresh the activity planner display. The start date/time field 404 and end date/time field 406 permit a user to enter or select a start date/time and an end date/time, respectively. Preferably, the user's settings of the date/time range are stored when the activity planner is closed and applied the next time the user opens the activity planner.

Day View And Care Plan View Tabs

Two views provided for the care plan include a day view 700, as shown in FIGS. 7, 8 and 9 and care plan view 400, as shown in FIGS. 4, 5 and 6. The day view 700 organizes the activities and associated information by date. The care plan view 400 presents the activities grouped by care plans. Preferably, a user switches between the two views of the activity planner by clicking on the tabs labeled “day view” or “care plan view.” Alternatively, selection buttons may be used. When the tab of the inactive view is clicked on, the view switches immediately with the current filter settings (e.g., the date/time range box 402 and the show active care plans only box 410) remaining valid for the new view.

Show Active Care Plans Only Box

The show active care plans only box 410 permits the user to filter the activities displayed. If the user checks the box 410, only activities belonging to an active care plan are displayed. This means that care plans and their related activities are not displayed, if the status of the care plan is cancelled, complete, or invalid. Activities that are cancelled or completed are displayed, provided the care plan they are associated with is still active. Activities not assigned to a care plan are displayed, regardless of status. By default, the show active care plans only box 410 is unchecked. The patient-problem that is associated (if such an association exists) with an activity may also be displayed (not shown in the figures) for each care plan in the care plan view 400.

Show Deleted Care Plans Only Box

Further, a check box labeled show invalid care plans box (not shown in the figures) may also appear on the activity planner to filter the activities displayed. Ideally, this option should only be available if invalid care plans exist for that particular patient. If checked, the activity planner displays only those care plans that have been previously deleted. Associated activities are also displayed. Preferably, this check box is unchecked by default.

Status Field

A status field 408 provides a filter that allows a user to display activities of a certain status. By default, activities of all status, except for the invalid status, is displayed upon accessing the activity planner. The status field 408 presents the user with a list of activity status and provides a mechanism for selecting one or more status, such as a combination field control. The invalid status is also available as a selection.

Day View And Care Plan View Windows

A first window on the left hand side of the activity planner provides two different views including the day view listing all the activities chronologically by date, and the care plan view listing the activities by care plan. The columns in the first window label all core properties of the activities for each view. The second window on the right hand side of the activity planner provides an activity chart, preferably displayed as a Gantt chart. The junction or frame between the first and second windows is adjustable, by clicking and sliding the frame between left side and right side directions, to permit the maximum view of the left hand side or right hand side window, as desired by the user.

Day View

In the day view 700, all activities are sorted chronologically by date. Each date provides a list of all activities that are to be performed for that patient on the corresponding date.

Care Plan View

In the care plan view 400, all activities are sorted by care plan. The care plans are sorted in order of creation. The last section lists all activities not associated to a care plan. The label for that row is “other activities.”

Columns Control

Due to screen-size limitations, not all columns are always visible or displayed at full width. Standard windows type features for columns control are provided, including right sizing a column by double clicking on its right border and right sizing all columns by pressing Ctrl-Shift-+.

Columns Displayed In The Activity Planner

Start Date Label

Preferably, a start date under the start date label 432 is a required property of all activities and refers to the date the activity is to go into effect. The format of the start date is similar the format of the short date setting on the client device's desktop. A user may edit a cell under the start date label 432 directly by double-clicking on the cell to give the user access to a calendar control function for setting the date. After the user edits a cell, the activities are then resorted.

Start Time Label

A start time under the start time label 440 is an optional input. For medications, the start time reflects the first administration time for the particular date. The format of the start time is similar the format of the short time setting on the client device's desktop. A user may edit a cell under the start time label 440 directly by double-clicking on the cell to give the user access to a calendar control function for setting the time. Preferably, activities having overlapping times, such as start times, durations and end times values are displayed in red to highlight the overlap to the user.

If there is no start date and start time specified, the activity planner defaults to the actual date and time when the activity is activated. The user may activate a care plan having consecutive days (day 1, day, 2, etc.), without entering a start date and a start time. In this case, the activity planner assigns an activation date and time as the start date and start time for the activities listed for day one and assign the following date for day two, and so on. The start time cell remains blank, except for the activities on day one. For activities that are scheduled within the scheduling module, the start date and time will reflect the scheduled date and time.

Care Plan Label

In the day view 700, the activity planner displays a care plan name under the care plan label 422 for all activities that are associated with a care plan. If the activity is not associated with a care plan, the cell remains empty. In the care plan view 400, the care plan name is displayed only once in the first row for that care plan and is empty in all other columns. The heading for activities that are not associated to a care plan shall be ‘other activities’. In either the day view 700 or the care plan view 400, if the care plan has a problem(s) associated with it, the care plan may have a ‘+’ in front of it. Clicking on the ‘+’ reveals the name of the problem(s). This implementation is similar to the presentation of associated care plans on the problem list. Preferably, the cells under the care plan label 422 in the care plan view 400 are always read only. Double clicking on a cell under in this column has no effect in the care plan view. However, in the day view 700, double clicking on a cell under the care plan label 422 toggles the care plan view and scrolls the selected care plan to the first displayed row.

Goals Label

The activity planner may also have a goals label provided with the day view 700 or the care plan view 400. The goals label and corresponding features are not shown in the figures. Goals are patient specific outcomes that are expected results of performing activities identified by the care plan. Goals may be associated at the care plan level or even at the individual activity level. For goals to be associated to an activity, the activity needs to be a part of the care plan. Goals may be defined for a varying time, such as on daily basis or for longer time durations even extending past an inpatient stay. The health professionals providing care for the patient typically document whether goals are met or unmet, often providing an explanation for goals that are not met. Not meeting a defined goal is considered a variance and is usually tracked across patients. Goals may also be referred to as expected outcomes or objectives.

If goals have been defined during the configuration of a care plan template, they are displayed in the goals column, in the rows for that care plan. Goals that are defined during the configuration of a care plan template may be associated to specific activity templates that comprise the care plan template. Those goals will be displayed in the goals column of the activity planner, in the same row as the associated activity.

A user may add a goal in the activity planner by right clicking on a care plan name in the care plan column or by right clicking on an activity name in the activity column and selecting the menu option “add goal.” The system presents the user with a goals detail screen that has a field for entering or selecting a goal description, and an optional field to specify a target date with the ability to select a day of discharge as a target value. After making the entries and clicking the ok button, the activity planner displays an icon in the goals column for the row of the care plan or activity. Clicking on the icon displays the goal description and the target date, if desired.

Goals may be modified, if they are no longer appropriate for the patient. For a user to modify or add a goal to a care plan or specific activity that is part of a care plan, the user must be in the row corresponding to the care plan or the activity to be sure that the action will affect the desired item (the care plan or the activity). The user right clicks in the goals column and select a menu option named “goal details.” The activity planner displays the goal details screen and the user, who has editing privileges, is permitted to change the fields on the screen.

The activity planner may also provide the user with the ability to select from a catalog of predefined goals. In this case, the activity planner provides the ability to search, browse, etc. Certain users may have the ability to create a new goal in the event that a service/activity has not been predefined. The activity planner adds the selected goals to the patient treatment plan.

Service Classification Label

A service classification is a healthcare service provided to the patient, such as lab or radiology services. Most activities are configured in a way that they are related to a service classification under the service classification label 424. For example, activities in a medication module have a service classification of “medication.” However, if an activity is not directly related to a service classification, the service classification label 424 displays the value ‘unclassified.’ If adjacent activities have the same service classification the cells are unified and the service classification name is displayed once at the top of that joined cell. The cells under the service classification label 424 are preferably read only. Double clicking on the cells under the service classification label 424 does not produce any effect. A user may hide the activities grouped for a specific service classification by an expand/collapse feature. The user may indicate display preferences for having the activities displayed as collapsed or expanded by service classification upon accessing the activity planner.

Activity Label

Various activities are associated with a care plan. An activity's name is displayed under the activity label 426. The frequency of the activity may be displayed after the name of the activity. For medications, the name of the medication and the dosage is displayed for each day that the medication is prescribed for the patient (e.g., Tylenol 1×3). A medication that is prescribed on an alternative day schedule is not displayed on the days that it is not planned for to the patient. The individual administrations for a given day are not listed as separate activities.

An “order description as written” feature may appear under the activity label 426 of the activity planner and under an editor for the care plan template. The “order description as written” feature is a concatenation (i.e., combination) of other order detail fields to represent a single summary line of key information to describe an order as typically written by the physician. The activity planner provides support for the format of the “order description as written” feature on the order lists, the user's order session summary, and associated order documents that are viewed online or printed. The fields included and the sequence in which the fields are included, etc. are defined by the organization (e.g., Chem 7 Q2 hrs M thru F until D/C, Type and screen Q4 hrs daily×3 days, etc.).

The formula can vary by order type (e.g., lab, radiology, cardiology, dietary, etc.) and/or by organization. Limited conditions may also be provided. The activity planner provides a model version of the formulas to streamline the setup process, along with a default format, but the user has the ability to tailor this format for the type of order within the enterprise. An example of a concatenation formula is provided below for a diagnostic order.

Name

Priority (Do not display this field, if this field includes “ROUTINE,” “routine,” or “Routine”)

Daily Frequency (Do not show this field, if this field includes “ONCE,” “once,” or “Once”)

Weekly Frequency (Do not show this field, if this field includes “ONCE,” “Once,” “once,” “DAILY,” “Daily,” or “daily”)

Duration/Duration unit of measure (UOM) information (This field does not show any duration information, if the duration is 0 HOURS, 0 Hours, 0 hours, 0 DAYS, 0 Days, 0 days, 0 SECONDS, 0 Seconds, 0 seconds, etc., for each valid UOM. If the duration is open ended, then display duration or show text “until Discontinued.” If the duration is greater than 0 and the duration UOM is valued, then display the following: ‘X’ (used to indicate times), Duration, Duration UOM (e.g., hours, months, days, weeks, minutes, seconds, etc.))

Double-clicking on an activity name under the activities label 426 opens an activity details screen. For example, double clicking on a medications activity displays a prescription editor with a focus on the selected patient, selected medication, and corresponding date. The prescription editor is provided as read only. Activity packages (e.g., departmental packages) are displayed in a collapsed view, showing the name of the package. Expanding the activity package displays the contents of the activity package. The activity planner displays an activity that repeats over several days once for each day for which it is scheduled. An indicator (e.g., curved arrow) may appear in front of the activity.

Outcome Label

The cells in the column under the outcome label 428 provide the result associated with the activity or an icon representing a link to the result. Examples of types of results include numeric, alphanumeric, document association, etc. If the activity does not have an outcome, the cells in the outcome column are grayed out and not available for edit. The operation of the outcome cells varies according to the result type indicated at the time of configuration, as described below for numeric, alphanumeric, document and packages.

The activity planner displays the numeric results, including the value and the units, directly in the cell. Double-clicking on a cell having the numeric result does not have effect for activities whose results are received via an external interface. For activities whose results are manually entered, double clicking on a cell having the numeric result causes the activity planner to present a data entry box for the user to enter the value of the result. For an activity that is repeated on a given day, the activity planner displays the results for each occurrence. For instance, an activity called temperature that has a frequency of three times per day displays the three entries for the temperature value. All of the entries are not visible at once due to space constraints. However, the activity planner has a means of flagging or indicating to a user that there is more data, such as a ‘+’ sign that expands to show the additional results.

The activity planner represents the alphanumeric results by an icon, regardless of whether they are a string or a blob field (but always discrete and unformatted). Double-clicking on the icon (or in the cell) opens a text viewer (e.g., a simple window with an ‘ok’-button) displaying the result. Results received from an interface may not be edited from the activity planner. For those activities that are manually entered, double clicking on the outcome cell presents a data entry box to permit a user to enter and edit the results. Results for activities repeated on a given day are displayed when the icon is clicked.

The activity planner represents the documents by another icon. Double-clicking on the icon (or in the cell) opens the corresponding document. Entries made for repeated activities are visible in the same document.

The activity planner represents the medication administrations by another icon. Double clicking on the icon or in the cell containing the icon opens the corresponding medication administration with a focus on the selected medication for the corresponding date and patient. Preferably, the medication administrations screen is read only. The user is permitted to see all of the administrations for the medication for a given day.

The activity planner does not display a result at the package name level. When the package is expanded, the results corresponding to the components of the package are displayed in their respective outcome cells, according to the type of result configured for that activity. Right clicking in the outcome column for a component of the package provides the menu options “result flowsheet,” which provides access to the result flowsheet of an order and results module, and “medication administration,” which provides access to an administration part of the medication module.

Status Label

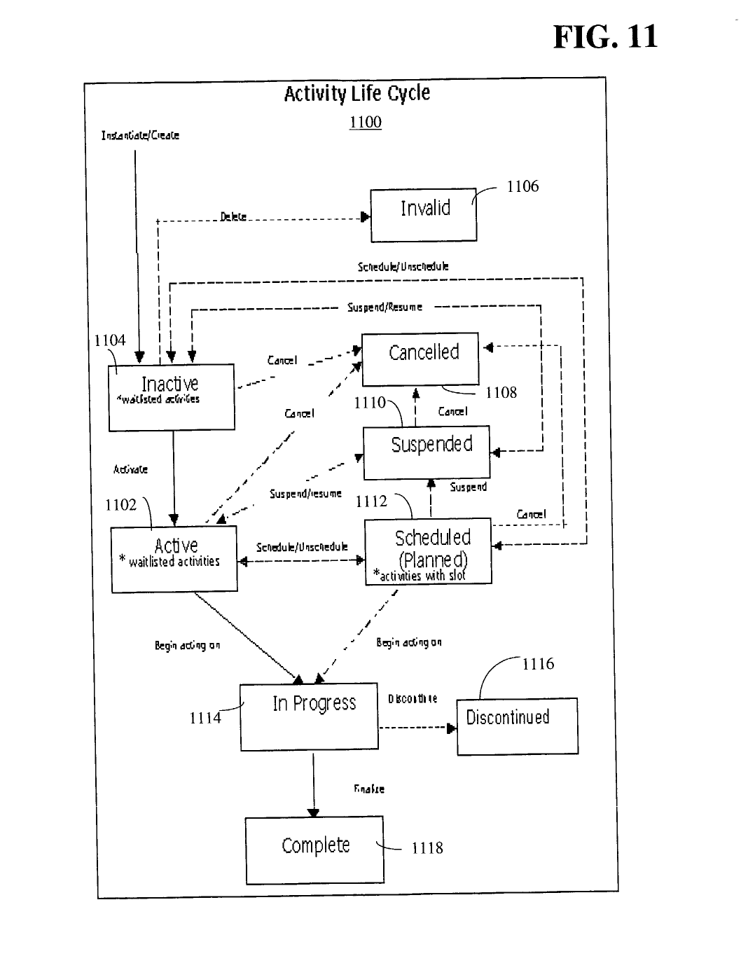

The activity planner displays the status of an activity under the column having the status label 430. Preferably, the cells in this column are not directly modifiable, and can only be modified using a context menu in order to avoid inadvertent changes. The activity planner displays various statuses as described with reference to the activity life cycle, as shown in FIG. 11. The medication module uses a subset of the statuses, but does not display individual statuses in the activity planner. For those activities originating from the orders and results module, a mapping of statuses links them to generic statuses used by the activity planner. Double clicking on the status cell of any activity displays a history of the activity's status transitions. Information for each activity includes the statuses that the activity has had using the origin module's status names, the date of the status change, and the name of the user that caused the status change. The activity planner displays the status of the activities associated with a package separately when the package is expanded.

The activity planner displays the status as it relates to the type of activity, thus being descriptive and meaningful. For example, the status of a lab order shows whether the status is “pending, sample to be collected,” “sample collected, sent to lab,” etc. The following table shows examples of various order status or interface order status associated with various activity statuses.

| Order Status | Activity Status |
|---|---|
| Ordered, unsigned | Inactive |
| Pending, unsigned | Inactive |
| Pending, sample to be collected, | Inactive |
| unsigned | |
| Ordered, signed | Active |
| Pending, signed | Active |
| Pending, sample to be collected, | Active |
| signed | |
| Pending, labels printed | In Progress |
| Sample collected, sent to lab | In Progress |
| Sent | In Progress |
| Check In | In Progress |
| Preliminary Result | In Progress |
| Final Result | Complete |
| Corrected Result | Complete |
| Interface Order Status | Activity Status |
| Order Received | Inactive, if the order is not signed. |
| | In Progress, if the order is signed. |
| Sample Being Received | In Progress |
| On Hold | Suspended |
| Sample Collected | In Progress |
| Cancelled | Cancelled |
| In Process | In Progress |
| Replaced | In Progress |
| Stored | In Progress |
| Partial Result | In Progress |
| Preliminary Result | In Progress |
| Final Result | Complete |
| Result Checked In | Complete |
| Result Signed | Complete |
| Correction | Complete |

Duration Label

The activity planner displays a duration of an activity under the duration label 442. The duration displayed includes a numerical value and unit of time. For activities that have a “requires scheduling” flag not set, the duration of an activity can be edited directly by double-clicking on the duration or the cell having the duration to permit the user to set the numerical value and the unit of time. For activities that do have the “requires scheduling” flag set, double-clicking duration or the cell having the duration opens a scheduler dialog box.

End Date and Time Label

The activity planner displays an end date and time of an activity under the end date/time label 444. Preferably, the end date and time is calculated using the start date and time and duration of the activity. Preferably, the end date and time are read only. Hence, clicking on the end date/time label 444 or any of the cells under the label does not have any effect. Preferably, the format of the end date and time are similar to the date and time format on the client workstation. Ongoing medications display an arrow in this column.

Comments Label

The activity planner displays comments associated with an activity under the comments label 446. The cells under the comments label 446 provide a free text field having a preferred limit of 255 characters. Any predefined comments made for the activity planner are also displayed under this label. Comments under the comments label 446 are edited directly by double clicking one the comment or the cell containing the comment. For medications, comments related to administration are displayed under this label by clicking on an icon that displays a read only of the administration tool and does not permit editing by the user.

Evaluation Label

The activity planner permits evaluation notes associated with an activity to be entered in an evaluation field an evaluation label (not shown in the figures). Care plans are evaluated periodically against the goals and the activities performed for the patient. The patient's progress or lack of progress towards achievement of the treatment goals is typically documented. A variance refers to a deviation of patient outcomes from the established patient goals and/or other standards. Tracking of variances over time across patients may serve to provide organizations with insight into quality issues. A user documents the patient evaluation and any variance in the evaluation field. Preferably, the evaluation notes and variances are documented in a documentation module. The activity planner links these notes to the care plans and associated problems and to individual activities, if desired. Review information, such as review date/time, user name, and comments, entered from a “review care plan” menu option are displayed in an evaluation field. The user accesses the existing evaluation notes by clicking an icon in the evaluation field. Viewing previous entries and adding a new entry is also possible. To enter a new evaluation note, a user will right click and select the menu option “enter evaluation note.” The activity planner displays the evaluation note and permits the user to select a reason for the variance from a predefined list and/or to enter text. Preferably, the activity planner flags an evaluation note using an indicator of some type. The activity planner also provides a visual indication of an activity that had been added to a care plan that was not originally part of the original care plan template. The activity planner also tracks this type of variance and provides the organization with a report regarding the use of their standard care plan templates.

Activity Chart

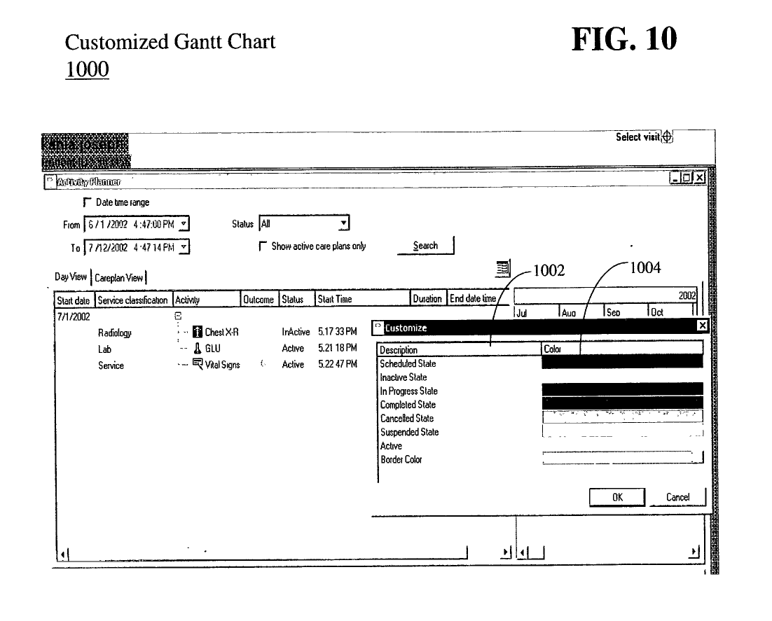

The activity planner has an activity chart that appears on the right hand side of the window when the icon 414 is selected. Preferably, the activity chart is a Gantt chart having a beam displayed on a time line for each activity. A user may modify the granularity of the time-line and the activity planner preserves the modified setting as a default for the next time the user opens the activity planner. The available grades are year, month, week, day, hour and minute. The user may filter the display by a date/time range. The beam is displayed based on the date, start time and duration of the activity. If the activity does not have duration, but a start time defined, a diamond is displayed instead of a beam. If the activity has neither a start time nor a duration defined, the beam is displayed for the full 24 hours of the date of the activity. The beam is color-coded to reflect the status of the activity. The association of the colors to the statuses is customizable, as shown in FIG. 10.

Sorting of rows in the Activity Planner

Preferably, the primary sorting criterion is fixed, and is the start date label 432 in the day view 700 and the care plan label 422 in the care plan view. The sorting is in the order of creation, but ‘other activities’ shall always be last. The user determines the secondary sorting criterion by clicking on the column label in a conventional manner (e.g., first click for ascending, second click for descending sorting order.) In the care plan view 400, the default sorting is first by care plan name, second by date, third by service classification and fourth by activity name. In the day view 700, the default sorting is first by date, second by service classification, and third by activity name.

Menus And User Interaction

Preferably, the activity planner has context sensitive popup menus. The context menu shall be row based, meaning that it is indifferent to the column pointed to and only the row pointed to is considered. The menu items for the context menu displayed in activity rows are the following in the given order, from top of the menu:

“Activity Details” causes the activity details screen is presented to user. —dividing line—

“Activate” changes the status of an “Inactive” activity to “Active.”

“Process” changes the status of an “Active” or “Scheduled” activity to “In Progress.”

“Complete” changes an “In Progress” activity to the “Complete” state.

“Suspend” places an “Inactive” or “Active” activity on hold and changes the status to “Suspended.”

“Resume” returns a “Suspended” activity to its former state of “Inactive” or “Active.”

“Cancel” cancels an “Inactive” or “Active” activity. The status of the activity is changed to “Cancelled.”—dividing line—

“Schedule” provides the ability to schedule an “Inactive” or “Active” activity that is schedulable. This menu item brings the user to the scheduling module where the activity can be scheduled or put onto a waitlist. Those activities that are assigned to a slot will have a status of “Scheduled.” Those activities that remain on a waitlist maintain their status “Inactive” or “Active.”

“Cancel Schedule” provides the ability to release the scheduled activity from its slot in the scheduling module. It does not cancel the activity. The status of the activity returns to the status it held before becoming scheduled. —dividing line—

“Add Activity” provides the ability to insert a new activity. The user is brought to the activity template catalog to select an activity template to add to the activity planner. The user will be able to select and access order and results templates from the catalog browser. Medications may also be integrated into the catalog browser.

“Delete Activity” deletes an “Inactive” activity and changes its state to “Invalid.” The activity is removed from the activity planner.

“Add Goal” system presents user with a goal details screen and user is permitted to enter a goal description and target date.

“Print—Activity List, Activity Details” provides two print functions. The user is permitted to print an activity list and/or details for one or more selected activities.

Any menu item that is not valid for the activity pointed to at the time is grayed out. For example, for activities not flagged as requiring scheduling, the “Schedule” item is grayed out. Further, for example, for a suspended activity, all action items except “Resume” are grayed out.

Medication Activity Menu

Right clicking on a medication activity preferably only has the following menu options.

“Activity Details” displays a prescription editor with focus on selected medication for the given date.

“Activate” is enabled for “Inactive” medications. The user has access to the medication module to activate the medication.

“Print—Activity List, Activity Details” provides two print functions. The user is permitted to print an activity list and/or details for one ore more selected activities.

Context Menu For Care Plan Rows In The Care Plan View Only

The menu items for the context menu displayed in Care Plan rows include the following (in the given order, from top):

“Care Plan Details” presents the care Plan details screen to the user. This screen provides the user with details regarding the care plan, such as name of care plan, code, description, date assigned to patient, care plan status, name or user id of user who assigned the care plan to the patient. —dividing line—

“Add Care Plan” presents the care plan catalog is presented to the user.

“Create Care Plan” presents the care plan template editor to the user. —dividing line—

“Delete Care Plan” permits the user to delete a care plan from the activity planner. Preferably, only care plans with all activities in the “Inactive” state may be deleted.

“Review Care Plan” permits the user to document that the selected care plan(s) has been reviewed. The activity planner presents the user with a dialog box that states “This care plan/care plans has been reviewed.” There is a field to enter an optional comment, such as an evaluation note. When the user clicks the ok button, the activity planner retains the review date and time, evaluation note, and user name and title. The review date and time are visible from the evaluation column and is linked to the associated care plan. Double clicking on the cell causes an evaluation details screen to be displayed. The name and title of the user and the evaluation note is displayed. An alternative means of access to the evaluation details will be by right clicking on the cell and selecting the menu option labeled “evaluation details.”

“Add Goal” presents the user with the goal detail screen to permit the user to enter the goal description and target date information.

“Cancel Care Plan” cancels “Inactive,” “Active,” and “Suspended” activities associated with the care plan.

“Print Care Plan” provides the ability to print the selected care Plan(s).

All menu items, that are not valid for the care plan pointed to at the time, are grayed out.

Double-Click Action In The Activity Planner

The double-click action shall be determined by the individual item pointed to. The double-click action is specified for each column in the description above.

Selecting Of More Than One Row Or Activity Column Cell

A user may select more than one row or activity column cell in a standard manner, such as by dragging the mouse with left button pressed or by holding down the Shift key or Ctrl-key while clicking on the cells or column. The only available menu item in this case shall be “Activate.”

Inserting Of Activities In The Day View

When the user selects the “add activity” menu item from the context menu while in the day view, the activity planner opens the service catalog. When a user selects an activity and, if required, its specific properties are set in the activity details dialog, the activity planner inserts the activity into the activity planner view, according to it's properties, such as date, service classification, start time etc. The new activity is not associated with a care plan when selected from the day view. During this step, the activity planner window remains open.

Inserting Of Activities In The Care Plan View

When the user selects the ‘add activity’ menu item from the context menu while in the care plan view, the activity planner opens the service catalog. The activity chosen is associated with the care plan in whose section of the activity planner view the context menu was called from (i.e., where the user has clicked). If the context menu was called from the ‘other activities’ section, the new activity is not associated with a care plan. When an activity is selected and, if required, its specific properties are set in the activity details dialog, the activity planner inserts the activity into the activity planner view, according to it's properties, such as date, service classification, start time etc. During this step, the activity planner window remains open.

Insert A Care Plan In The Care Plan View

When a user selects the ‘Add Care Plan’ menu item from the context menu, the activity planner opens the care plan template catalog. During this step, the activity planner window remains open.

Activity Details

The activity details screen provides the user with a view of the details of the selected activity. The purpose of the activity details view is to provide the user with the information that was contained within the activity template at the time it was applied to a patient.

Care Plans

Once the patient's problems are identified, certain clinical users are responsible for establishing and maintaining the treatment plan for a patient. Patient specific goals are determined and activities are planned to achieve the goals in the treatment plan. The treatment plan essentially outlines the planned activities that are to be performed for a particular patient. The user can view and update the overall treatment plan from the activity planner. The activities for the patient are organized into one or more care plans. The care plans address the particular problems that the patient presents with. During the course of a patient's treatment, the care plan is reviewed and monitored. Clinical users typically document the progress of the patient's care and the outcome of the interventions, or activities that are carried out. In some cases, new activities are be added, and in other cases, activities that are no longer appropriate are discontinued or modified.

A care plan is either created from a care plan template or from scratch using an empty care plan template. A care plan may be associated with a patient problem, but does not have to be. This is determined by the way user selects the care plan template. Once a care plan is associated with a patient, it can be viewed and updated from the activity planner. Those care plans that are associated with patient problems may be accessed via the patient problem list.

Creating A Care Plan For A Patient

Selecting A Care Plan Template Associated With A Patient-Problem

A user may create a care plan associated with a patient problem by one of two methods. A care plan template may be selected from a list of associated care plan templates in a problem template catalog. Alternatively, a care plan template catalog may be invoked from the patient-problems list by right clicking on a problem and selecting the “add care plan” menu-item.

Selecting A Care Plan Template Not Associated With A Patient Problem

Alternatively, a user may create a care plan associated not with a patient problem by invoking the catalog of care plan templates directly, either from the desktop's menu-bar or from the context-menu in the patient browser.

Selecting A Care Plan Template In The Care Plan Template Catalog

When the user selects a care plan template from the care plan template catalog, the care plan opens to permit the user to make any modifications.

Creating A New Care Plan From Scratch

A user may create a care plan from scratch for a patient by starting from an empty care plan template. This may be done from the patient-problem list by right clicking on a selected problem and choosing the “create care plan” menu item. The care plan is associated with the problem that has been selected. The other option is to create the care plan from the activity planner. Once created, the care plans may be used just as any other care plan template. Preferably, care plans created in this manner are not saved in the catalog of care plan templates for future use. However, users may save the care plans created in a favorites folder for their individual use.

Handling Of Duplicate Activities Based On The Same Activity Template

When a new activity is about to be created, whether in the process of instantiation of a care plan template or otherwise, the activity planner checks whether another activity based on the same activity template already exists. The activity planner requires that there be a start date before checking for duplicates can begin. For inactive activities that do not have a start date, the activity planner makes the duplicate determination at the time the activity is activated, at which time the activity planner assigns the current date if not specified otherwise by the user.

Marking Of Activities With Overlapping Periods Of Time

Whenever a new activity is created that has a value for both start time and duration attributes set, or whenever an existing activity's start time and/or duration values are modified, the activity planner checks whether there is an overlap in time with any other activity. If such an overlap exists, the values displayed in the start time, duration and end time columns of the activity planner for the affected activities are highlighted in red.

Managing Care Plans And Activities

The activity planner provides the user with a view of all of the care plans and related activities for a patient. Care plans can be created, added, and modified from the activity planner. Activities can also be created, added, and modified from the activity planner.

Indirect Changes Of The Care Plan's Status Through Status Changes Of Its Activities

When a user creates a care plan, the care plan is assigned an initial status of inactive. All the activities that are created with the care plan also have the same status of inactive. When the first activity in the care plan is activated, the care plan itself is set to a status of “active” automatically. When the first activity in the care plan is set to “in progress,” the care plan is set to a status of “in progress” automatically. The care plan then remains in the status of “in progress” until the last activity has reached a status of either “complete,” “invalid,” or “cancelled.” The status of the care plan is determined in the following manner:

The care plan is set to a status of “complete,” if at least one activity belonging to the care plan has a status of “complete.”

The care plan is set to a status of “cancelled,” if none of the activities in the care plan have been finalized (e.g., status of “complete”), but at least one activity has been cancelled.

The care plan is set to a status of “invalid,” if all activities in the care plan have a status of “invalid.” In this case, the care plan is no longer displayed in the activity planner, but is stored in the database. The user may view invalid care plans by selecting the checkbox “show deleted care plans” in the activity planner.

Deletion Of A Care Plan

A user may delete a care plan, if none of its activities have been activated. This function will be used for situations when the care plan that has been added or created is inappropriate for the patient and/or has been erroneously selected. The user deletes a care plan by selects the care plan, right clicking, and selecting the ‘delete care plan’ option from the menu. The activity planner presents the user with a dialog box where the user has the ability to enter a reason for the deletion. The default choice is “erroneous entry.” The user has the option to select “other” and explain further in a text box.

A deleted care plan has a status of invalid and the activity planner removes it and its activities from the display in the activity planner. The care plan is stored in the database. The user is permitted to view a list of invalid care plans for a patient by selecting the check box “show deleted care plans,” if available, from the activity planner. Upon refresh, the activity planner displays the invalid care plans. The option is only enabled if invalid care plans exist for the patient. The display for the activity planner in this mode is identical to the care plan view of activity planner, except that it lacks the activity chart 450 and the “show active care plans” checkbox. The invalid care plans are listed with their associated activities collapsed. The user may view the details of care plans by opening the associated activities. The reason for deletion is displayed in the care plan details screen. Deletion of a care plan is also possible from the context menu of the care plan in the patient problem list.

Ending Of A Care Plan

The user may cancel a care plan at any time, causing all the care plan's activities to be cancelled that can be cancelled (only those of status “inactive,” “active,” “scheduled,” or “suspended”). All other activities (e.g., “in progress,” or “completed”) are not cancelled. The status of the care plan may only change when the last activity “in progress” is either complete or cancelled. When the user selects the menu option “cancel care plan,” the activity planner provides the user with a dialog box to optionally to enter the reason using free text or to select a reason from predetermined selections. A care plan may be also cancelled from the care plan context menu of the patient problem list.

Review Care Plan

Preferably, the user has the ability to review a care plan and record that the care plan has been performed. The activity planner provides this function as a right click menu option in the care plan column. After selecting this option, the activity planner presents the user with a dialog box that states that the care plan has been reviewed. A field permits the user to enter an optional text comment, such as an evaluation note. When the user clicks the ok button, the activity planner retains the review date and time, evaluation note and user name and title. This information is visible from the evaluation column, if available, and is linked to the associated care plan. Preferably, this implementation supports the ability to see the evaluation note within the context of other notes entered for the patient.

FIG. 10 illustrates a display window of the activity planner, as shown in FIG. 1, showing a customized activity chart 1000, in accordance with a preferred embodiment of the present invention. The customized activity chart 1000 generally includes a description label 1002 and a color label 1004. Various activity states, such as scheduled, inactive, in progress, completed, cancelled, suspended, and active, or other display features, such as border color, listed under the description label are assigned and correspond to various different colors listed under the color label. A user may enter or select various descriptions for various activity states and enter or select various colors to correspond to those activity states. Preferably, the colors for the activity states are different from each other, but some may be the same, if desired. The colors advantageously permit a user to quickly visually identify the activity state displayed in the activity chart 450 in the care plan view, as shown in FIG. 6, or in the day view, as shown in FIG. 9. Other distinguishing identifiers, such as shapes, patterns, shades, and the like, may be used in combination with or as an alternative to colors while providing the same visual advantages.

FIG. 11 illustrates an activity life cycle chart 1100 associated with the activity planner, in accordance with a preferred embodiment of the present invention. The activity life cycle chart 1100 illustrates various states including active 1102, inactive 1104, invalid 1106, cancelled 1108, suspended 1110, scheduled (planned) 1112, in progress 1114, discontinued 1116, and complete 1118, and various transitions (not numbered) between the states. The activity life cycle chart 1100 shows permitted states and movements between the states for the activities associated with a care plan for a patient.

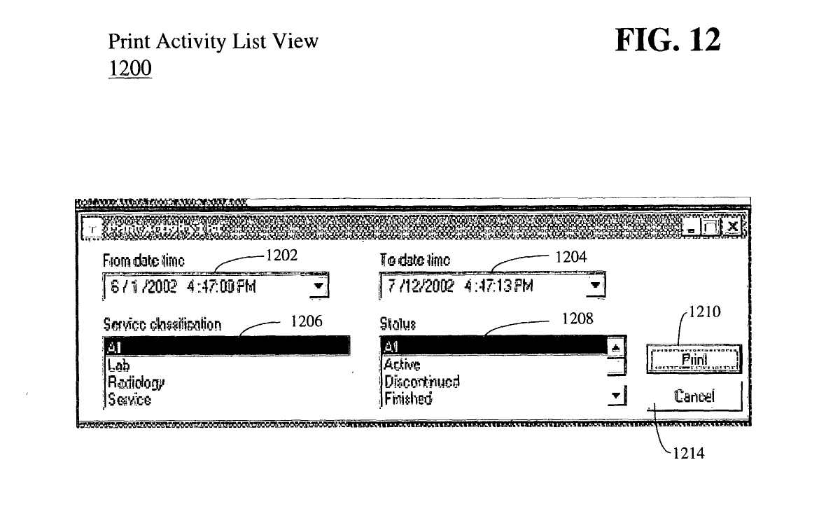

FIG. 12 illustrates a display window of the activity planner, as shown in FIG. 1, showing a print activity list view 1200, in accordance with a preferred embodiment of the present invention. The print activity list view 1200 generally includes a beginning date/time field 1202, an end date/time field 1204, a service classification field 1206, a status field 1208, a print button 1210, and a cancel button 1214. The user is permitted to enter or select a beginning date/time into the beginning date/time field 1202, and to enter or select an ending date/time into the ending date/time field 1204 to form a date/time range over which the activity list from a care plan is searched for printing. In the service classification field 1206, the user is permitted to enter or select one or more service classifications to search for and print out. In the status field 1208, the user is permitted to enter or select one or more status state to search for and print out. The user clicks on the print button 1210 to initiate the search and print function. The user clicks on the cancel button 1214 to reset the print activity list view 1200.

The activity planner prints a heading on each page, containing identifying information for the patient that is common across the information system. Preferably, the information is the same information that is contained within the patient header. The heading “patient care plan” appears as a title on each of the pages. The filter criteria appear under the title. The page number and total number of pages are included in the footer of the pages. The date of printing is included in the header of the pages The user accesses a “print care plan” menu option from the care plan column by right clicking on the care plan. Upon selecting this option, the user is presented a screen and has the ability to specify printing criteria, as noted above. Any of these selections will produce a document that resembles the care plan information as it is displayed in activity planner. The activity planner may also print information valued in the fields of the care plan and activity details screen that isn't represented in one of the columns of the activity planner. This information is printed underneath the care plan name and activity name. The activity planner provides the ability to display a preview of what will be printed. The user may also access “print care plan” from the patient menu item in the desktop.

In the windows displayed in FIGS. 3, 4, 5, 6, 7, 8, 9, 10 and 12, each of the sections and the individual elements of the sections may be located at any place in the window and should not be limited to the particular located represented in the figures. Further, each of the sections and the individual elements of the sections may be implemented in various similar ways, to achieve the same result, which are well known in the art to those that design user interfaces. For example, the user may enter a command using a manual entry, a drop down window, an icon, a predetermined list, or voice recognition via a microphone, and the like. Further, for example, the information may be presented to the user using a display, having windows, files, text, graphics, images, charts, or lists, and the like, or using voice generation via a speaker.

Hence, while the present invention has been described with reference to various illustrative embodiments thereof, the present invention is not intended that the invention be limited to these specific embodiments. For example, the architectures, windows, menus and processes presented in FIGS. 1-10 are not exclusive. Other architectures, windows, menus and processes may also be derived in accordance with the principles of the invention to accomplish the same objectives. Further, the inventive principles may be advantageously employed in any activity planner system and is not limited to use in the healthcare field. Those skilled in the art will recognize that variations, modifications and combinations of the disclosed subject matter can be made without departing from the spirit and scope of the invention as set forth in the appended claims.

What is claimed is:

1. A method for monitoring patient related treatment activities, comprising the steps of:
acquiring data identifying activities scheduled for a patient as well as data associated with outcomes corresponding to said scheduled activities;
collating said acquired data to provide collated data that is suitable for presentation in a single view of a display indicating said identified scheduled activities and said corresponding outcomes, together with a time line indicating a scheduled date of occurrence of said scheduled activities; and
processing said collated data for communication to a reproduction device.

2. A method according to claim 1, including the steps of:
acquiring information identifying a treatment plan for said patient, wherein said activities are activities within said acquired treatment plan; and
collating said acquired data to provide collated data that is suitable for presentation in the single view of the display indicating said identified scheduled activities and said corresponding outcomes, together with said information identifying said treatment plan.

3. A method according to claim 2, including the step of:
adaptively selecting between processing said collated data that is suitable for presentation in the single view of the display together with one of:
the time line indicating the scheduled date of occurrence of said scheduled activities, and
said information identifying said treatment plan, in response to user command.

4. A method according to claim 1, wherein
said time line indicates a scheduled time of occurrence of said scheduled activities.

5. A method according to claim 1, wherein
the outcomes are represented by a document forming a multimedia file including at least one of, (a) a still video image, (b) a video image sequence, (c) an audio segment, (d) a patient diagnostic image and (e) a graphical trace.

6. A method according to claim 5, wherein
the patient diagnostic image comprises at least one of (i) an MRI scan, (ii) an x-ray, (iii) a PET scan, (iv) a sonogram, and
the graphical trace comprises at least one of (I) an EKG trace, (II) an ECG trace and (III) an EEG trace.

7. A method according to claim 1,
wherein the collated data is displayed in a table format, wherein the table format is displayed in the first window of the single view of the display, wherein the time line is displayed in the second window of the single view of the display, wherein the first window is displayed next to the second window in the single view of the display, wherein horizontal rows in the table format correspond to horizontal graphics of the time line, wherein the time line is visually color coded to correspond to a status of a corresponding scheduled activity.

8. An activity planner for a healthcare information system comprising:
a user interface including:
an input device adapted to receive input information related to a care plan for a patient, wherein the care plan includes a schedule of activities related to treatment of a problem for the patient; and
a display adapted to present, in a single view, the input information, output information related to the care plan, and an activity chart related to the care plan, wherein the activity chart provides a graphical representation of the schedule of activities in the care plan; and
a processor adapted to generate the output information responsive to receiving the input information.

9. An activity planner according to claim 8 wherein the activity chart further comprises:
a Gantt chart.

10. An activity planner according to claim 8 wherein the graphical representation of the schedule is a time line.

11. An activity planner according to claim 8:
wherein the input information and the output information are displayed in a table format, and
wherein the activity chart is displayed in a graphical format.

12. An activity planner according to claim 11:
wherein the table format is displayed in a first window of the single view of the display, and
wherein the graphical format is displayed in a second window of the single view of the display.

13. An activity planner according to claim 12 wherein the input device further comprises at least one of:
a horizontal scroll means permitting a user to move horizontally within at least one of the first window and the second window, and
a vertical scroll means permitting a user to move vertically within at least one of the first window and the second window.

14. An activity planner according to claim 12 wherein the input device further comprises:
selection means for permitting a user to at least one of open and close the second window.

15. An activity planner according to claim 12 wherein
the first window is displayed next to the second window in the single view of the display.

16. An activity planner according to claim 15 wherein
horizontal rows in the table format correspond to horizontal time line graphics in the graphical format.

17. An activity planner according to claim 16 wherein the input device further comprises:
visual means for separating the first window and the second window, wherein the first window becomes larger and smaller, and the second window becomes smaller and larger, respectively, responsive to the vertical bar being moved towards the second window, and wherein the first window becomes smaller and larger, and the second window becomes larger and smaller, respectively, responsive to the vertical bar being moved towards the first window.

18. An activity planner according to claim 8 wherein the schedule in the activity chart is visually coded to correspond to a status of a corresponding activity.

19. An activity planner according to claim 18 wherein the code is color.

20. An activity planner for a healthcare information system comprising:
a user interface including:
an input device adapted to receive input information related to a care plan for a patient, wherein the care plan includes a schedule of activities related to treatment of a problem for the patient,
wherein the input device further includes at least one of:
a horizontal scroll means permitting a user to move horizontally within at least one of a first window and a second window, and
a vertical scroll means permitting the user to move vertically within at least one of the first window and the second window,
wherein the input device further includes:
selection means for permitting a user to at least one of open and close the second window
wherein the input device further includes:
visual means separating the first window and the second window, wherein the first window becomes larger and smaller, and the second window becomes smaller and larger, respectively, responsive to the vertical bar being moved towards the second window, and wherein the first window becomes smaller and larger, and the second window becomes larger and smaller, respectively, responsive to the vertical bar being moved towards the first window.; and
a display adapted to present, in a single view, the input information, output information related to the care plan, and an activity chart related to the care plan, wherein the activity chart provides a graphical representation of the schedule of activities in the care plan, wherein the graphical representation of the schedule is a time line, wherein the input information and the output information are displayed in a table format, wherein the activity chart is displayed in a graphical format, wherein the table format is displayed in the first window of the single view of the display, wherein the graphical format is displayed in the second window of the single view of the display, wherein the first window is displayed next to the second window in the single view of the display, wherein horizontal rows in the table format correspond to horizontal time line graphics in the graphical format, wherein the schedule in the activity chart is visually color coded to correspond to a status of a corresponding activity; and
a processor adapted to generate the output information responsive to receiving the input information.
